(19) United States
(12) Patent Application Publication
(10) Pub. No.: US 2026/0250215 A1
(43) Pub. Date: Aug. 27, 2026

(54) DIRECTIONAL HUMIFICATION MICROFACTORY FOR AGRICULTURAL WASTE COMPOSTING AND USE THEREOF

(71) Applicant: TIANJIN NORMAL UNIVERSITY, Tianjin (CN)

(72) Inventors: Zimin WEI, Tianjin (CN); Bingqi SHEN, Tianjin (CN); Yue ZHAO, Tianjin (CN); Weiye TAO, Tianjin (CN); Chunlei PANG, Tianjin (CN); Xijuan PANG, Tianjin (CN)

(73) Assignee: TIANJIN NORMAL UNIVERSITY, Tianjin (CN)

(21) Appl. No.: 19/422,523

(22) Filed: Dec. 17, 2025

(30) Foreign Application Priority Data
Feb. 24, 2025 (CN) 202510206745.1

(51) Int. Cl. C05F 17/993; C05F 17/70

(52) U.S. Cl. CPC C05F 17/993; C05F 17/70

(57) ABSTRACT

A directional humification microfactory for agricultural waste composting and a use of the directional humification microfactory are provided. The directional humification microfactory for agricultural waste composting includes the following treatment units: a raw material preparation unit for humic acid (HA) synthesis configured to enable enhanced depolymerization of lignocellulose to release an HA precursor; an HA production unit configured to allow directional synthesis of the HA from the HA precursor; and an HA storage unit configured to immobilize and store the HA. According to actual conditions such as the type of agricultural waste and the composting region, a suitable technical method is preferably selected in each unit for an optimized combination to produce a composting process applicable to regional characteristics.

### CROSS REFERENCE TO THE RELATED APPLICATIONS

This application is based upon and claims priority to Chinese Patent Application No. 202510206745.1, filed on Feb. 24, 2025, the entire contents of which are incorporated herein by reference.

### TECHNICAL FIELD

The present disclosure belongs to the technical field of resource utilization, and specifically relates to a directional humification microfactory for agricultural waste composting and use thereof.

### BACKGROUND

Agricultural waste, waste generated during agricultural production, mainly includes biomass residues resulting from production activities in farming, forestry, animal husbandry, fishery, and other industries. Among them, lignocellulosic organic solid waste predominates. Lignin, as a protective structure, covers the surfaces of cellulose and hemicellulose, which restricts the utilization of the internal cellulose and hemicellulose to some extent. Due to the protective effect and recalcitrance of lignin, traditional aerobic composting methods struggle to utilize readily-depolymerized components such as proteins and organic acids during the composting process, making the depolymerization of organic components asynchronous from the generation of aromatic compounds as HA (HA) precursors. Aromatic compounds mainly come from lignocellulosic components. Their metabolic process is relatively slow, which further exacerbates the imbalanced nutrient utilization by microorganisms, and leads to the heavy loss of easily-depolymerized organic components. Consequently, the production of HA precursors becomes asynchronous, resulting in a low content of humic substance. Humic substances can hardly be immobilized, and is easily decomposed and dissipate, which reduces the overall efficiency of composting. Moreover, in traditional aerobic composting processes, HA are prone to depolymerization and can hardly remain stable, further compromising the efficiency of aerobic fermentation and the quality of the final product.

### SUMMARY

In view of this, an objective of the present disclosure is to provide a directional humification microfactory for agricultural waste composting. In the directional humification microfactory, the three different continuous treatment units of a raw material preparation unit for humic acid (HA) synthesis, an HA production unit, and an HA storage unit are provided to significantly increase HA content in a compost and allow the stable immobilization and storage of the HA.

The present disclosure provides a directional humification microfactory for agricultural waste composting, including the following treatment units arranged sequentially:

a raw material preparation unit for HA synthesis configured to enable enhanced depolymerization of lignocellulose to release an HA precursor;

an HA production unit configured to allow directional synthesis of the humic substance from the precursor for HA synthesis; and

an HA storage unit configured to immobilize and store the humic substance produced in composting.

In some embodiments, in the raw material preparation unit for HA synthesis, a method for enhancing depolymerization of the lignocellulose is determined according to an abundance of a lignocellulosic waste in a composting raw material: when the composting raw material is deficient in the lignocellulosic waste, a biological enhanced depolymerization method is adopted; and

when the lignocellulosic waste is abundant in the composting raw material, a biological or non-biological coupling-enhanced depolymerization method is adopted.

In some embodiments, the biological enhanced depolymerization method includes an aromatic nucleus preparation process in which depolymerization of lignocellulose is enhanced with a crude enzyme broth from microbial inoculant fermentation; and

the biological or non-biological coupling-enhanced depolymerization method includes at least one selected from the group consisting of a process for enhancing depolymerization of lignocellulose based on Fe(II)/functional microorganism-enhanced Fenton-like oxidation, a process for enhancing depolymerization of lignocellulose based on KOH depolymerization-HNO=neutralization and microbial inoculation, and an aromatic nucleus preparation process in which depolymerization of lignocellulose is enhanced based on coupling of Mn(II) with a functional microorganism.

In some embodiments, in the HA production unit, a method for the directional synthesis of HA from the HA precursor is determined according to an abundance of a lignocellulosic waste in a composting raw material: when the lignocellulosic waste is deficient in the composting raw material, a process for directional humification based on protein waste composting combined with addition of HA-synthesizing aromatic nucleus precursor as a functional material is adopted; and

when the lignocellulosic waste is rich in the composting raw material, a process for directional humification based on lignocellulosic waste composting and coupling of staged protein precursor feeding with functional material catalysis is adopted.

In some embodiments, in the HA storage unit, a method for immobilizing and storing the HA is determined according to an abundance of minerals or chitosan in a composting region: when there is an abundant amount of clay minerals in the composting region, a process for passivating labile HA with clay minerals in aerobic fermentation is adopted;

when the composting region is a coastal region where shell-derived chitosan is abundant, a process for producing and immobilizing labile HA with shell-derived chitosan is adopted; and

in other composting regions, a microhabitat factor regulation process is adopted.

In some embodiments, a method for the aerobic fermentation is intermittent aeration.

In some embodiments, a process of the intermittent aeration is as follows: starting aeration at the beginning of the aerobic fermentation, making each aeration last for 2 h, and allowing aeration once every 6 h,

where an aeration rate for each aeration is 0.25 L/min to 0.5 L/min.

The present disclosure provides use of the directional humification microfactory for agricultural waste composting in the agricultural waste composting.

In some embodiments, the use includes: adjusting a C/N ratio and a moisture content in a composting raw material before enhanced depolymerization of lignocellulose,

where a method for adjusting the C/N ratio in the composting raw material is as follows: adding urea to the composting raw material to adjust the C/N ratio to 25 to 30; and

the moisture content in the composting raw material is adjusted to 60 wt% to 70 wt%.

The present disclosure provides a directional humification microfactory for agricultural waste composting, including the following treatment units: a raw material preparation unit for HA synthesis configured to enable enhanced depolymerization of lignocellulose to release an HA precursor; an HA production unit configured to allow directional synthesis of HA from the HA precursor for HA synthesisHA; and an HA storage unit configured to immobilize and store the HA produced in composting. In the present disclosure, lignocellulose in agricultural waste is first depolymerized with the raw material preparation unit for HA synthesis to improve the depolymerization efficiency of lignin during aerobic fermentation. Moreover, the HA production and storage units may significantly increase the contents of HA and allow the stable immobilization and storage of HA. According to experimental results, compared to the composting under the traditional mode alone, the directional humification microfactory process may significantly stabilize and increase the contents of HA, enhance the depolymerization efficiency of lignocellulose, and improve the quality of a product. The content of HA precursor such as polyphenol, amino acids, and reducing sugar during aerobic fermentation is also detected. Results show that the content of any HA precursor decreases over time. Moreover, compared to the composting under the traditional mode alone, the directional humification microfactory process may significantly improve the content of HA precursor and thus greatly promote the process of synthesizing HA from the precursor. In the present disclosure, the total content of humic substances and the content of each humic substance in the compost during aerobic fermentation are also measured. Results show that, with the extension of an aerobic fermentation time, the content of humic substances gradually increases, the content of FA decreases, and the content of HA increases. In the humification treatment group, the content of HA is significantly improved, and the contents of FA and HA are each higher than those under the traditional composting mode. Accordingly, the directional humification microfactory process may effectively drive the conversion of various components into HA, increasing the content of HA, and improving the composting efficiency and the product quality.

Further, in the present disclosure, according to different amount lignocellulosic waste, such as straws, in a composting raw material, different technologies are adopted to allow the enhanced depolymerization of lignocellulose, which may improve the depolymerization efficiency of lignocellulose and consequently increase the lignocellulose content in the raw materials for HA synthesis. In the present disclosure, according to the abundance of lignocellulosic waste in a composting raw material, different technologies are adopted for directional humification of composting, and different technologies are also adopted for the immobilization and storage of HA. As a result, not only the content of HA is significantly increased, but also the depolymerization efficiency of the synthesized HA is reduced, thereby facilitating the content enhancement and the immobilization and storage for HA in the compost.

### BRIEF DESCRIPTION OF THE DRAWINGS

FIGS. 1A-1B show dynamic changes in HA precursor contents during aerobic fermentation, where FIG. 1A shows changes in amino acid contents during aerobic fermentation and FIG. 1B shows changes in polyphenol contents during aerobic fermentation;

FIGS. 2A-2D show dynamic changes in HA contents during aerobic fermentation, where FIG. 2A shows changes in humic substance contents during aerobic fermentation, FIG. 2B shows changes in HA contents, FIG. 2C shows changes in fulvic acid (FA) contents, and FIG. 2D shows changes in organic matter contents;

FIGS. 3A-3D show dynamic changes in basic physical and chemical indexes and HA precursor contents during aerobic fermentation, where FIG. 3A shows changes in organic matter contents during aerobic fermentation, FIG. 3B shows dynamic changes in pH during aerobic fermentation, FIG. 3C shows changes in reducing sugar contents during aerobic fermentation, and FIG. 3D shows changes in amino acid contents during aerobic fermentation;

FIGS. 4A-4C show dynamic changes in humic substance contents during aerobic fermentation, where FIG. 4A shows changes in humic substance contents during aerobic fermentation, FIG. 4B shows changes in FA contents, and FIG. 4C shows changes in HA contents; and

FIGS. 5A-5D show dynamic changes in humic substance contents and organic matter contents during aerobic fermentation, where FIG. 5A shows changes in humic substance contents during aerobic fermentation, FIG. 5B shows changes in FA contents, FIG. 5C shows changes in HA contents, and FIG. 5D shows changes in organic matter contents.

### DETAILED DESCRIPTION OF THE EMBODIMENTS

The present disclosure provides a directional humification microfactory for agricultural waste composting, including the following treatment units arranged sequentially:

a raw material preparation unit for HA synthesis configured to enable enhanced depolymerization of lignocellulose to release a precursor (an aromatic compound) for HA synthesis ;

an HA production unit configured to allow directional synthesis of the HA from the precursor for HA synthesis; and

an HA storage unit configured to immobilize and store the HA produced in composting.

In the present disclosure, technical selections are conducted in the three units of the directional humification microfactory based on actual conditions, and then agricultural waste is subjected to aerobic fermentation under the optimal conditions.

In the present disclosure, in the raw material preparation unit for HA synthesis, a method for the enhanced depolymerization of the lignocellulose is determined according to an abundance of a lignocellulosic waste in a composting raw material: when the lignocellulosic waste is deficient in the composting raw material, a biological enhanced depolymerization method is adopted. When the lignocellulosic waste is rich in the composting raw material, a biological or non-biological coupling-enhanced depolymerization method is adopted. The standard for determining whether the lignocellulosic waste is deficient in the composting raw material is preferably as follows: When an agricultural waste rich in lignocellulose, such as straws, in a region cannot meet the C source content requirement of a C/N ratio (25-30/1) in the normal aerobic fermentation for composting, with the need for additional C source supplementation, it can be determined that the lignocellulosic waste in the composting raw material is deficient during an aerobic fermentation process of the agricultural waste in this region. The standard for determining whether the lignocellulosic waste is abundant in the composting raw material is preferably as follows: when an agricultural waste rich in lignocellulose, such as straws, in a region sufficiently meets the C source content requirement of a C/N ratio ((25-30)/1) in normal aerobic fermentation for composting, without the need for additional C source supplementation, it can be determined that the lignocellulosic waste in the composting raw material is abundant during the aerobic fermentation of the agricultural waste in this region. The biological enhanced depolymerization method preferably includes an aromatic nucleus preparation process in which depolymerization of lignocellulose is enhanced with a crude enzyme broth from microbial inoculant fermentation. The aromatic nucleus preparation process in which depolymerization of lignocellulose is enhanced with a crude enzyme broth from microbial inoculant fermentation preferably includes: performing liquid fermentation using a carbon source with a high induction capacity for lignocellulose-depolymerizing enzyme production in a functional microorganism, and after lignocellulose-depolymerizing enzymes are secreted in large quantities by the functional microorganism, inoculating a resulting crude enzyme broth into straws for composting. There are mainly the following three methods for selecting the functional microorganism: 1. Dilution culture: A sample is diluted to an appropriate concentration to facilitate the natural growth of oligotrophic microorganisms without being suppressed by dominant microfloras among microfloras, thereby increasing the likelihood of microbial proliferation. Microbial populations are diluted to trace amounts, and then the isolation and purification can be conducted by a dilution-plate method to obtain a novel strain that has not been reported. 2. High-throughput culturing (HTC): A sample to be treated is diluted with an oligotrophic medium to about 10³ cells/mL, and then 14% of microorganisms in the sample are cultured in a 48-well (small volume) culture plate, which improves the culturing efficiency. 3. With the fluorescence in situ hybridization (FISH) technique, a probe for the molecular identification of an unculturable evolutionary clade of a target stain is designed, such that the presence of microorganisms in each well of the culture plate can be rapidly detected in a targeted manner. This method can effectively monitor the target strain in a short period and facilitate the scale-up culture of the target strain. When an actinomycete is used as the functional microorganism, the sample is first subjected to enrichment culture by the traditional pure culture method, and Congo red-staining is used to identify transparent zones on the medium for selection. The selected target strain is identified by a molecular biology method. When the strain is identified as Actinobacteria through 16S rDNA identification, physiological and biochemical studies are conducted for the strain to provide a reliable basis for further research on the strain. After being selected and isolated, the functional microorganism is subjected to related microbial activity assays, such as microbial enzyme activity assay, cellulase activity assay, and molecular identification. The selected functional microorganism has advantages such as thermophilic performance, psychrophilic performance, and high depolymerization rate. The functional microorganism used for enhancing the depolymerization of lignocellulose preferably includes at least one selected from the group consisting of a bacterium, a fungus, and an actinomycete. The bacterium may be Bacillus subtilis deposited in the China Center of Industrial Culture Collection (CICC) with an accession number of CICC 10071, or Bacillus amyloliquefaciens deposited in the China Center of Industrial Culture Collection (CICC) with an accession number of CICC 10074. The fungus may be a functional microbial strain Z1 (Aspergillus fumigatus) deposited in the China General Microbiological Culture Collection Center (CGMCC) with an accession number of AF202956.1, Thermomyces lanuginosus deposited in the China Center for Type Culture Collection (CCTCC) with an accession number of CCTCC AF 200043, or Geotrichum sp. deposited in the China Center for Type Culture Collection (CCTCC) with an accession number of CCTCC AF 2012006. The actinomycete may be Thermoactinomyces intermedius deposited in the China Center of Industrial Culture Collection (CICC) with an accession number of CICC 10671, or Streptomyces phaeolivaceus deposited in the China Center of Industrial Culture Collection (CICC) with an accession number of CICC 24807. The crude enzyme broth from microbial inoculant fermentation is preferably prepared by conducting fermentation and scale-up culture with a functional microorganism. When a bacterium or a fungus is used as the functional microorganism, the fermentation is conducted at preferably 30° C to 40° C and more preferably 37° C. When Thermoactinomyces intermedius is used as the functional microorganism, the fermentation is conducted at preferably 40° C to 60° C and more preferably 55° C. When Streptomyces phaeolivaceus is used as the functional microorganism, the fermentation is conducted at preferably 25° C to 36° C and more preferably 30° C. When a bacterium is used as the functional microorganism, the fermentation is conducted for preferably 10 h to 30 h and more preferably 25 h. When a fungus is used as the functional microorganism, the fermentation is conducted for preferably 3 h to 5 h and more preferably 4 h. When an actinomycete is used as the functional microorganism, the fermentation is conducted for preferably 4 h to 14 h and more preferably 10 h. The fermentation is conducted according to the aerobic or anaerobic requirement of the functional microorganism. After the fermentation is completed, preferably, the fermentation broth is subjected to solid-liquid separation at 4° C, and the liquid phase is collected as the crude enzyme broth. The solid-liquid separation is conducted at a rotational speed of preferably 2,800 rpm to 3,200 rpm and more preferably 3,000 r/min. The centrifugation is conducted for preferably 13 min to 17 min and more preferably 15 min. The amount of the crude enzyme broth from microbial inoculant fermentation inoculated is 1% of a dry weight of the composting raw material. In this method, because high-concentration lignocellulose-depolymerizing enzymes are introduced in large quantities into the fermented crude enzyme broth and the initial temperature rise period (30° C to 50° C) of composting provides an appropriate working temperature for the lignocellulose-depolymerizing enzyme system, this rapid breakdown of lignocellulosic structures results in compost products that can serve as functional materials or precursors for aromatic nuclei. It has been verified through experiments that the method may enhance the depolymerization efficiency of cellulose during composting, with a specific improvement ranging from 34.47% to 38.32%. The liquid fermentation culture using a carbon source with high induction capacity, also known as liquid fermentation culture using a carbon source that produces high induction effect, is specifically as follows: The lignocellulose-depolymerizing enzyme-expressing functional microorganism is cultured in a preferred fermentation medium with a significant induction and promotion effect to allow the mass production of the lignocellulose-depolymerizing enzymes.

In the present disclosure, the biological or non-biological coupling-enhanced depolymerization method preferably includes at least one selected from the group consisting of the following: a process for enhancing depolymerization of lignocellulose based on Fe(II)/functional microorganism-enhanced Fenton-like oxidation, a process for enhancing depolymerization of lignocellulose based on KOH depolymerization-HNO=neutralization and microbial inoculation, and an aromatic nucleus preparation process in which depolymerization of lignocellulose is enhanced based on coupling of Mn(II) with a functional microorganism. The process for enhancing depolymerization of lignocellulose based on Fe(II)/functional microorganism-enhanced Fenton-like oxidation is preferably as follows: Fe(II) is added to a compost, and a functional strain Z1 (Aspergillus fumigatus) is inoculated into the compost. This strain has a high capacity for producing peroxidases. Thus, it may serve as an efficient hydrogen peroxide-producing carrier to establish a Fenton-like reaction with Fe(II), thereby producing highly oxidative (·OH). The source of Fe(II) is preferably ferrous sulfate or ferrous chloride. The amount of Fe(II) added is 0.5% of a dry weight of the composting raw material. In some embodiments, the amount of the functional strain Z1 inoculated is 2% of a dry weight of straws. It has been verified through experiments that the hydroxyl radical can efficiently depolymerize and disrupt the structure of lignocellulose. The traditional Fenton reaction relies on the reaction of Fe(II) with hydrogen peroxide to produce the highly-oxidative hydroxyl radical (·OH) to destroy the structure of lignin. Unlike the Fenton reaction, the Fenton-like reaction in the process for enhancing depolymerization of lignocellulose based on Fe(II)/functional microorganism-enhanced Fenton-like oxidation involves the addition of a functional strain Z1 as the hydrogen peroxide-producing carrier. The functional microbial strain Z1 (Aspergillus fumigatus) and Fe(II) both are added to a compost to establish the Fenton-like reaction, which can effectively increase the depolymerization rate of lignin during aerobic fermentation. It has been verified through experiments that the Fenton-like reaction can enhance the average depolymerization efficiency of lignin to 26% to 30%. Moreover, the HA production and storage units can significantly increase the content of HA. It has been verified through experiments that the HA production and storage units can improve the content of HA to 7.48% to 8.34%, and allow the stable immobilization and storage of HA. The functional microbial strain Z1 (Aspergillus fumigatus) includes a fungal strain with an accession number of AF202956.1 from the China General Microbiological Culture Collection Center (CGMCC).

In the present disclosure, the process for enhancing depolymerization of lignocellulose based on KOH depolymerization-HNO=neutralization and microbial inoculation is preferably as follows: A lignin-rich raw material is subjected to pre-depolymerization for 24 h with 1.25 mol/L KOH. The pre-depolymerization is conducted at preferably 20° C to 30° C and more preferably 25° C. After the neutralization with HNO₃, a lignocellulose-decomposing strain is inoculated for composting. Before the inoculation, the pH of the composting raw material is preferably 6.8 to 7.2. The straws are taken and chopped to a particle size of 1 cm to 2 cm. According to a ratio of 2:1 (w/v) (that is, 1 L of a KOH solution is applied to every 2 Kg of straws), 2,500 L of the KOH solution at a concentration of 1.25 M is uniformly sprayed on the straws, stirring is fully conducted, and then standing is allowed for 48 h. After the alkaline solution fully reacts with the straws, according to a ratio of 4:5 (w/v) (that is, 2.5 L of a HNO₃ solution is applied to every 2 kg of the straws), 6,250 L of the HNO₃ solution at a concentration of 0.5 M is uniformly sprayed on the straws for neutralization, followed by complete stirring, and 48 h of standing. In some embodiments, the lignocellulose-decomposing strain includes a functional strain Z1 (Aspergillus fumigatus, a fungal strain with an accession number of AF202956.1 from the China General Microbiological Culture Collection Center (CGMCC)), Bacillus subtilis (a bacterial strain with an accession number of CICC 10071), and Bacillus amyloliquefaciens (a bacterial strain with an accession number of CICC 10074). The amount of the lignocellulose-decomposing strain inoculated is preferably 1.8% to 2% of a dry weight of straws. Experiments have shown that pretreatment with the alkali can damage the waxy structure of the straw and make the surface structure rough, thereby creating favorable conditions for the habitation and catabolism of the functional microorganism. Research has confirmed that this process increases the polyphenols as HA precursors, involves easy operations and no secondary pollution compared with the traditional depolymerization using NaOH , improves the carbon sequestration efficiency through the addition of protein precursors for directional humification at a later stage, and greatly increases the nutrients of N and K in the composting product.

In the present disclosure, the aromatic nucleus preparation process in which depolymerization of lignocellulose is enhanced based on coupling of Mn(II) with a functional microorganism preferably means that Mn(II) can serve as not only a cofactor in the synthesis of peroxidases, but also an activator for various enzymes such as decarboxylase, kinase, and transferase. Based on this, a process for enhancing decomposition of lignocellulose through coupling of Mn(II) with Thermomyces lanuginosus is developed. Mn(II) preferably includes MnSO₄·7H₂O, which acts as an enzyme inducer. The amount of Mn(II) added is preferably 1‰ of a dry weight of rice straw. Thermomyces lanuginosus is deposited in the China Center for Type Culture Collection (CCTCC), with an accession number of CCTCC AF 200043. Thermomyces lanuginosus, as a lignin-depolymerizing functional strain, can play a lignin-depolymerizing role. The amount of Thermomyces lanuginosus inoculated is preferably 1% of the dry weight of the rice straw. Steps for enhancing the decomposition of lignocellulose through coupling of Mn(II) with Thermomyces lanuginosus are preferably as follows: Activated Thermomyces lanuginosus is inoculated in a fermentation medium and cultured at 30° C for 3 d to produce a fermentation broth. The fermentation broth is then added to the rice straw. When the moisture content is adjusted, Mn(II) is added to the rice straw to enable the decomposition of lignocellulose. It has been verified through composting that the depolymerization efficiency of lignocellulose can be significantly improved. During the composting, Mn(II) can also regulate the expression of coding genes for other enzymes by changing physical and chemical indexes, thereby participating in the metabolic network of lignocellulose. The composting product can serve as a functional material of aromatic nucleus precursor.

In the present disclosure, the raw material preparation unit for HA synthesis can enhance the rapid depolymerization of lignin-based agricultural waste and effectively improve the content of HA precursors, thereby efficiently increasing the content of HA.

In the present disclosure, in the HA production unit, a method for directional humification in composting is preferably determined according to the quantity of straws as a lignocellulosic waste in the composting raw material: When the lignocellulosic waste is deficient in the composting raw material, a process for directional humification based on protein waste composting combined with addition of HA-synthesizing aromatic nucleus precursor as a functional material is adopted. When the lignocellulosic waste is rich in the composting raw material, a process for directional humification based on lignocellulosic waste composting and coupling of staged protein precursor feeding with functional material catalysis is adopted. The standard for determining whether the lignocellulosic waste is abundant in the composting raw material is preferably as follows: When an agricultural waste rich in lignocellulose, such as straws, in a region cannot meet the C source content requirement of a C/N ratio ((25-30)/1) in the normal aerobic fermentation for composting, and a C source needs to be supplemented in other ways, it can be determined that there is a lack of a lignocellulosic waste in a composting raw material during an aerobic fermentation process of the agricultural waste in this region. The standard for determining whether the lignocellulosic waste is abundant in the composting raw material is preferably as follows: When an agricultural waste rich in lignocellulose, such as straws, in a region sufficiently meets the C source content requirement of a C/N ratio ((25-30)/1) in the normal aerobic fermentation for composting without the need of additional C source supplementation, it is determined that the lignocellulosic waste is abundant in the composting raw material during an aerobic fermentation process of the agricultural waste in this region. The process for directional humification based on protein waste composting combined with addition of HA-synthesizing aromatic nucleus precursor as a functional material is preferably as follows: Lignite and biochar that are rich in aromatic compounds, and aromatic nuclei produced from the enhanced depolymerization of lignin based on a crude enzyme broth from microbial inoculant fermentation and the coupling of Mn(II) with a functional microorganism are adopted as functional materials for HA frameworks. Research has confirmed that this process can enhance the aromatization degree of HA and increase the content of HA. During a composting cycle, the feeding of a HA-synthesizing protein aromatic nucleus precursor can be appropriately increased at vigorous microbial activity stages, which can promote the reproduction and metabolism of microorganisms and accelerate the decomposition and conversion of organic matters. The vigorous microbial activity stages are mostly early and middle stages of composting. At these stages, a temperature of a compost gradually arises until a high-temperature stage (the temperature of the compost is 55° C to 65° C) is reached. Therefore, at these stages, an abundant amount of the HA-synthesizing protein aromatic nucleus precursor should be fed. An addition amount of lignite or biochar rich in the HA-synthesizing protein aromatic nucleus precursor is 5% of a dry weight of the compost. In contrast, at a weak microbial activity stage, namely, a cooling stage of composting (the temperature of the compost is 20° C to 35° C), the addition amount of lignite or biochar rich in the HA-synthesizing protein aromatic nucleus precursor should be appropriately reduced to 1% to 3% (2%) of the dry weight of the compost, thereby avoiding resource waste and potential environmental pollution. In some embodiments, functional materials for the HA-synthesizing protein aromatic nucleus precursor are lignite, biochar, and aromatic nuclei produced from the enhanced depolymerization of lignin based on a crude enzyme broth from microbial inoculant fermentation and the coupling of Mn(II) with a functional microorganism (this part is mentioned in the raw material preparation unit for HA synthesis). The process for directional humification based on lignocellulosic waste composting and coupling of staged protein precursor feeding with functional material catalysis is preferably as follows: The staged feeding of a protein precursor is designed based on periodic changes in activities of microorganisms in the soil. During the composting cycle, the feeding of the protein precursor can be appropriately increased at vigorous microbial activity stages, which can promote the reproduction and metabolism of microorganisms and accelerate the decomposition and conversion of organic matters. The vigorous microbial activity stages are mostly early and middle stages of composting. At these stages, the temperature of a compost gradually arises until a high-temperature stage (the temperature of the compost is 55° C to 65° C) is reached. Therefore, at these stages, an abundant amount of the HA-synthesizing protein precursor should be fed. The addition amount of the protein precursor is 5% of a dry weight of the compost. In contrast, at the weak microbial activity stage, namely, a cooling stage of composting (the temperature of the compost is 20° C to 35° C), the addition amount of the protein precursor should be appropriately reduced to 1% to 3% of the dry weight of the compost, thereby avoiding resource waste and potential environmental pollution. In some embodiments, the HA-synthesizing protein precursor is kitchen waste or livestock and poultry manure such as a chicken manure and a cow manure. A functional material such as a nanomaterial with specific surface properties and catalytic activity or biochar is used in combination. This functional material can adsorb and enrich organic matters in the soil, and can accelerate the oxidation-reduction reaction of organic matters through catalytic active sites on the surface, thereby promoting the generation of HA. The protein waste includes a protein waste in kitchen waste or livestock and poultry manure.

In the present disclosure, in the HA storage unit, a method for immobilizing and storing the HA is preferably determined according to the abundance of minerals or chitosan in the composting region: When clay minerals are abundant in the composting region, a process for passivating labile HA with clay minerals in aerobic fermentation is adopted. When the composting region is a coastal region where shell-derived chitosan is abundant, a process for producing and immobilizing easily-available HA with shell-derived chitosan is adopted. In other composting regions, a microhabitat factor regulation process is adopted. The standard for determining whether clay minerals are abundant in the composting region is preferably as follows: When a clay mineral waste with strong adsorption capacity, such as loess or stratified soil, in this region sufficiently serves as a material for immobilizing HA during normal aerobic fermentation for composting, that is, an addition amount is allowed to be 8% or more of a dry weight of the compost, it is determined that the clay minerals are abundant in this region. The standard for determining whether shell-derived chitosan is abundant is preferably as follows: When a typical aquatic waste, such as shells, crab shells, and clam shells, in this region sufficiently serves as a raw material for bioconversion during normal aerobic fermentation for composting, that is, an addition amount is allowed to be 2% to 2.5% or more of a dry weight of the compost, it is determined that the clay minerals are abundant in this region. The process for passivating easily-available HA with clay minerals in aerobic fermentation is preferably as follows: The clay minerals may be added at an amount 8% of a dry weight of the compost during aerobic fermentation to achieve the stable immobilization and storage of HA. In some embodiments, the clay minerals are added after the large-scale synthesis of HA, namely, at a late high-temperature stage (40° C to 50° C) of composting. For the selection of clay minerals, stratified clay minerals with a low cost, large specific surface area, and strong adsorption capacity, such as montmorillonite and zeolite, are preferred, or loess with a lower cost than stratified clay minerals can be selected. Loess collected from the mountainous region may have a heavy metal residue, which pollutes the environment, damages the physical health, and significantly reduces the quality of the final composting product. Therefore, waste loess from a homestead may be selected and added to achieve waste control by waste. Moreover, the particle size of loess should be reduced as much as possible, and clay minerals should be thoroughly mixed in the compost. Experiments have confirmed that the addition of clay minerals during aerobic fermentation may stabilize the internal environment of the compost, reduce the mineralization of HA, and enhance the stable immobilization and storage of HA. The process for producing and immobilizing labile HA with shell-derived chitosan is preferably as follows: A typical aquatic waste is adopted as a raw material for bioconversion. Bacillus cereus, a highly chitin-deacetylating functional strain provided at an early stage of laboratory research, may be used for large-scale fermentation of the above two shell wastes to produce deacetylated chitosan as a crude product. The typical aquatic waste preferably includes crab shell and clam shell. After being collected, the typical aquatic waste should be preferably sun-dried to remove the excess moisture. The typical aquatic waste raw material is preferably fragmented to a length of preferably 8 cm to 12 cm and more preferably 10 cm. The fragmented aquatic waste is preferably pretreated. Specifically, the fragmented aquatic waste is preferably pretreated with Bacillus cereus, a highly chitin-deacetylating functional strain. Before the pretreatment, Bacillus cereus is subjected to activation culture. The inoculum size of Bacillus cereus is preferably 0.1%. The activation culture is conducted at preferably 45° C. The activation culture is preferably shaking culture. The shaking culture is conducted at a rotational speed of preferably 120 rpm to 140 rpm and more preferably 130 rpm. When the viable count of Bacillus cereus reaches 1.0 × 10⁸ CFU/mL, a resulting activated microbial solution is inoculated into a large fermentation tank to allow scale-up culture. Bacillus cereus produced after the scale-up culture is inoculated into the typical aquatic waste to allow large-scale fermentation, producing chitosan as a crude product. The amount of Bacillus cereus inoculated is 1% of a dry weight of the shell waste. The cycle of the large-scale fermentation is 5 d. According to the stoichiometric determination and calculation, the deacetylation degree of the crude chitosan converted from crab shell is 46.60%, the deacetylation degree of the crude chitosan converted from clam shell is 37.50%, and the deacetylation degree of chitosan from commercial source is about 95.50%. It has been confirmed through research that chitosan produced after deacetylation in the compost can allow the stable immobilization and storage of HA during humification. This process is a "waste control by waste" process that enables efficient resource utilization. The microhabitat factor regulation process is preferably as follows: The denitrification during composting is inhibited by reducing the moisture content, increasing the aeration rate, adjusting pH, and adding biochar to increase the content of HA and allow the stable immobilization and storage of HA. During the implementation of the microhabitat factor regulation, proper aeration may improve the product quality and enable the energy conservation. However, both excessive aeration (an aeration rate is 0.6 L/min·kg or more) or insufficient aeration (an aeration rate is 0.4 L/min·kg or less) can bring adverse impacts. Aeration can not only allow oxygen supply, dehumidification, and heat dissipation, but also affect the operating efficiency of the composting system. The aeration mode includes natural aeration, pile-turning, passive aeration, and forced aeration. The forced aeration is particularly crucial for the performance of a system. The aeration rate depends on the properties of raw materials. Excellent aeration is crucial for a quality of a product. Poor aeration may lead to the generation of anaerobic conditions and harmful gases or the excessive decomposition of organic matters. In some embodiments, the aeration rate is controlled at 0.45 L/min·kg to 0.55 L/min·kg (0.5 L/min·kg), which enables the optimal composting status. The composting temperature is a key factor affecting the metabolic activities of microorganisms and the composting process. The composting temperature determines the progress of composting. Based on the temperature change during the composting process, aerobic composting can be divided into the following four stages: heating stage, high-temperature stage, cooling stage, and maturation stage. A high temperature can accelerate the depolymerization of organic matters while killing pathogens. The high-temperature stage of the aerobic composting is preferably at 55° C to 60° C. The C/N ratio is directly related to the decomposition of organic matters. The too-high C/N ratio will affect the depolymerization of organic matters and prolong the composting time. A too-low C/N ratio can easily make excessive nitrogen converted into ammonia nitrogen and volatilized. Therefore, an appropriate C/N ratio can reduce the loss of nitrogen during composting and promote the progress of composting. An initial C/N ratio of livestock and poultry manure for composting is preferably 21 to 23 (22), which is conducive to the depolymerization of organic matters and the generation of HA. The moisture content is also a parameter that needs to be controlled and adjusted during the composting process. A too-low moisture content will affect the normal metabolism of microorganisms, thereby compromising the depolymerization rate of organic matters. A too-high moisture content can easily cause the local anaerobic conditions during composting, the production of foul gases, and the delay of maturation. Therefore, it is necessary to reasonably adjust the moisture content during the composting process. The moisture content is preferably 60% to 70% and more preferably 65%. The moisture content in the above range can effectively guarantee the growth and metabolism of microorganisms and promote the progress of composting. During the composting process, the pH increases and is maintained at 7.5 to 9. During the composting process of livestock and poultry manure, there is no need to manually adjust the pH. Generally, when the pH is higher than 7.0 and the composting sample turns dark-brown and enables a germination rate of 80% or more, the composting sample is considered fully matured. The inhibition on denitrification during composting through the addition of biochar and other manners refers to the feeding of a HA-synthesizing protein aromatic nucleus precursor to increase the content of HA. This part is described in the raw material preparation unit for HA synthesis. Studies have confirmed that the optimization of composting parameters can improve the local anaerobic microenvironment during composting and suppress the denitrification pathway. Moreover, the decline in the abundance and activity of denitrifying microorganisms capable of depolymerizing aromatic compounds and the reduction of their key role in the interspecific relationship inhibit the decomposition of aromatic compounds into monomeric compounds and restrict the depolymerization of labile components such as aromatic compounds for synthesizing HA. Therefore, the aromatic compound precursors closely related to the generation of HA are upregulated, and the content of HA increases.

In the present disclosure, a composting method based on the directional humification microfactory is provided. In some embodiments, according to the abundance of the resource in the composting region, a specific technique is selected for aerobic fermentation.

In the present disclosure, the raw material for the agricultural waste composting is crushed. When the raw material for the agricultural waste composting is crop straw or another type of waste, the raw material is crushed to a length preferably of 2 cm to 3 cm. The crushing is conducive to accelerating the depolymerization of lignin in lignocellulosic agricultural waste.

In the present disclosure, the raw material preparation for HA-synthesis preferably further includes adjusting the C/N ratio and moisture content in the raw material for the agricultural waste composting. The method for adjusting the C/N ratio during the raw material preparation for HA-synthesis is as follows: urea is added to the raw material for the agricultural waste composting to adjust the C/N ratio to preferably 25 to 30 and more preferably 28. The moisture content in the raw material for the agricultural waste composting is adjusted to preferably 60 wt% to 70 wt% and more preferably 65 wt%. The adjustment of the C/N ratio and moisture content is beneficial for the rapid reproduction and fermentation of microorganisms during the aerobic fermentation of lignocellulosic agricultural waste.

In the present disclosure, the method for the aerobic fermentation is preferably intermittent aeration. The process of the intermittent aeration is preferably as follows: aeration is started at the beginning of the aerobic fermentation, with each aeration allowed to last for 2 h, and aeration is allowed once every 6 h. The aeration rate for each aeration is preferably 0.25 L/min to 0.5 L/min, more preferably 0.3 L/min to 0.45 L/min, and most preferably 0.35 L/min. The gas introduced during the intermittent aeration is preferably oxygen. This aeration rate allows a microaerobic state. Some microorganisms can produce cellulosomes in an anaerobic state, which is effective for the depolymerization of lignocellulose. The aerobic fermentation is divided into the following five stages: an initial phase: 25° C to 30° C, a heating phase: 30° C to 50° C, a high-temperature phase: 50° C to 60° C, a cooling phase: cooling to 40° C, and a maturation phase: 40° C to 30° C. The aerobic fermentation is conducted for preferably 40 d to 50 d and more preferably 48 d.

The present disclosure has no special restriction on sources of the experimental chemicals such as ferrous sulfate and manganese dioxide involved in various technical methods for the three units of the directional humification microfactory, and any sources of the chemicals such as ferrous sulfate and manganese dioxide well known in the art may be adopted.

The present disclosure provides use of the directional humification microfactory for agricultural waste composting in the agricultural waste composting.

In the present disclosure, the directional humification microfactory can enhance the conversion of precursor substances and the generation and immobilization of HA while improving the depolymerization rate of lignin during aerobic fermentation. In the examples of the present disclosure, the dynamic changes in contents of HA precursors and HA in the compost produced after aerobic fermentation are determined. According to the results, compared with the control group of the traditional composting, the aerobic fermentation in the directional humification microfactory may significantly increase both the content of HA and the conversion rate of HA precursors. Moreover, with the extension of fermentation time, the advantage of increasing the content of HA is increasingly evident. The high conversion rate in the humification treatment group indicates that microorganisms may efficiently utilize lignin-based agricultural waste for thorough primary and secondary metabolism. Accordingly, it is verified that the pre-depolymerization process carried out by the raw material preparation unit for HA synthesis of the directional humification microfactory may efficiently decompose lignin and disrupt the structure of lignocellulose to enable the rapid depolymerization of lignin during aerobic fermentation of straws. Resulting HA are further synthesized and stabilized through the HA production and storage units. As a result, the present disclosure achieves the purpose of high-quality resource utilization.

The directional humification microfactory for agricultural waste composting and the use of the directional humification microfactory provided in the present disclosure are described in detail below with reference to the examples, but these examples should not be understood as limiting the claimed scope of the present disclosure.

### Example 1

A method for humic substance-producing composting based on a directional humification microfactory for agricultural waste composting was provided.

### 1. Raw materials

An organic solid waste treatment plant in Taigu County, Shanxi Province was selected as a demonstration project site for case implementation. Taigu County is a major agricultural county, and thus is rich in straws and other lignocellulosic waste. In addition, the southern part of Taigu County belongs to the Xiangyu River basin of the Taiyue Mountain Range, and the right side of Taigu County lies on the edge of the Taihang Mountain, resulting in abundant clay minerals. Therefore, in the raw material preparation unit for HA synthesis, a biological or non-biological coupling-enhanced depolymerization method was adopted, that is, a process for enhancing depolymerization of lignocellulose based on Fe(II)/functional microorganism-enhanced Fenton-like oxidation was adopted. In the HA production unit, a process for directional humification based on lignocellulosic waste composting and coupling of staged protein precursor feeding with functional material catalysis was adopted. In the HA storage unit, a process for passivating labile HA with clay minerals in aerobic fermentation was adopted.

Maize straws left after harvesting in the previous year were used as a composting raw material. A Z1 strain (Aspergillus fumigatus) AF202956.1 (from the China General Microbiological Culture Collection Center (CGMCC)) was used as the lignin-depolymerizing strain. Ferrous sulfate was added for Fenton-like effect. The protein materials included kitchen waste, pig manure, chicken manure, etc. Manganese sulfate was used as a catalyst for humification. Stratified clay minerals with strong adsorption capacity and waste loess from homesteads were used as humic substance-immobilizing agents. In this example, the aerobic composting method was customized according to local actual conditions. In this aerobic composting method, each component for composting was added at an amount according to the following standard: During the aerobic fermentation process for composting, the carbon-to-nitrogen ratio must be maintained at 30 and the moisture content needed to be maintained at about 65%. The amount of the microbial agent inoculated was 0.25% of a dry weight of the lignocellulosic material including straws. The amount of the ferrous sulfate added was 0.5% of the dry weight of the lignocellulosic material including straws. The amount of the protein material including chicken manure was 5% of a dry weight of the compost. The amount of the catalytic material manganese sulfate was 5‰ of the dry weight of the compost. The amount of the clay minerals added was 8% of the dry weight of the compost.

### 2. Aerobic fermentation

(1) In the raw material preparation unit for HA synthesis, a process for enhancing depolymerization of lignocellulose based on Fe(II)/functional microorganism-enhanced Fenton-like oxidation was adopted.

Before the aerobic fermentation was started, rice straws were crushed to a length of 2 cm to 3 cm, then the carbon-to-nitrogen ratio of the material was adjusted with urea to 25 to 30, and the moisture content of the material was adjusted with distilled water to about 65%. Z1 strain was selected for the scale-up culture and was inoculated to allow composting. For the activation culture, the ratio of the medium to the strain to be inoculated was 1,000:1. The activation culture was conducted at 45° C in a shake flask with a rotational speed of 130 rpm/min. When the concentration reached 1.0 × 10⁸ CFU/mL, a resulting activated microbial solution was inoculated into the available large fermentation tank in the plant for scale-up culture. The microbial solution produced after the scale-up culture was inoculated into pre-treated straws at an amount 0.25% of a dry weight of the straws. Fenton-like treatment: The traditional Fenton reaction relies on the reaction of Fe(II) with hydrogen peroxide to produce the highly-oxidative hydroxyl radical (·OH) to destroy the structure of lignin. Unlike Fenton reaction, Fenton-like reaction involves the addition of the functional strain Z1 as a hydrogen peroxide-producing carrier. Thus, the functional strain Z1 (Aspergillus fumigatus) and Fe(II) both were added to the compost to establish a Fenton-like reaction.

The amount of the functional strain Z1 (Aspergillus fumigatus) added was 0.25% of the dry weight of the straws. Ferrous sulfate was added as Fe (II) at an amount 0.5% of the dry weight of the composting raw material. The weighed FeCl₂ was added to a specified amount of distilled water, and stirring was fully conducted with a glass rod. Because the specified amount of water was added during a process of dissolving FeCl₂, in order to maintain the moisture content at about 65% during the composting, the moisture content should be adjusted after the FeCl₂ solution was mixed with materials. In addition, Fe(II) did not need to be prepared in advance, and could be prepared just before use.

(2) In the HA production unit, a process for directional humification based on lignocellulosic waste composting and coupling of staged protein precursor feeding with functional material catalysis was adopted.

About one week before the composting entered the high-temperature stage, protein precursors including chicken manure and kitchen waste were added at an amount 5% of a dry weight of the composting raw material, manganese sulfate was added at an amount 5‰ of the dry weight of the composting raw material, so as to achieve the coupling of precursor feeding with the catalytic material to promote the directional humification of organic components. When the high temperature lasted for a long time, the protein precursors were added once again during the high-temperature composting.

(3) In the HA storage unit, a process for passivating labile HA with clay minerals in aerobic fermentation was adopted.

For the selection of clay minerals, stratified clay minerals with low cost, large specific surface area, and strong adsorption capacity, such as montmorillonite and zeolite, could be utilized, or loess with a lower cost than stratified clay minerals could be selected. Mountainous regions of Shanxi have abundant loess. Thus, waste loess from a homestead or a mountainous region was selected and added at an amount 8% of the dry weight of the composting raw material. Moreover, a particle size of loess should be reduced as much as possible, and clay minerals should be thoroughly mixed in the compost.

The above was the directional humification microfactory. The material system treated by the three units was set as the humification treatment group, and the material system not treated by the three units was set as a control group. The two groups were simultaneously subjected to an aerobic fermentation experiment lasting for 43 d.

After the aerobic fermentation was completed, the compost was collected, tested for HA precursors such as amino acids, polyphenols, and reducing sugars, and further tested for dynamic changes in the humic substance content and the organic matter content. The following conclusions are drawn:

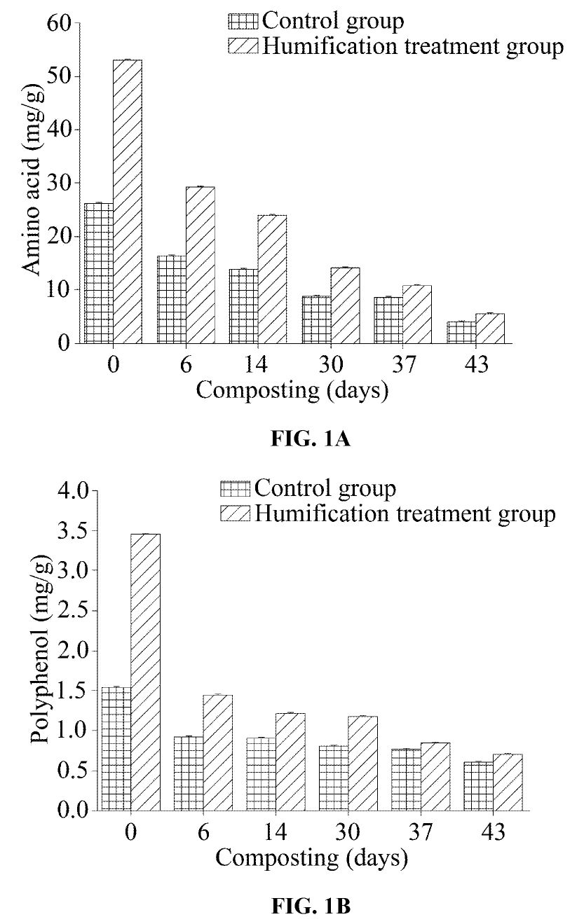

FIGS. 1A-1B show the content change curves of the HA precursors of amino acids and polyphenols during the aerobic fermentation process. It can be seen from FIG. 1A that, in both the humification treatment group and the control group, the amino acid content gradually decreased. Initially, the amino acid content in the humification treatment group was 52.97 mg/g, and an amino acid content in the control group was 26.12 mg/g. At a later stage of composting, the amino acid content in the humification treatment group was 5.45 mg/g, and the amino acid content in the control group was 3.84 mg/g. In the humification treatment group and the control group, conversion rates of amino acids were 89.7% and 85.3%, respectively. These indicates that, after the directional humification treatment in the microfactory, the content of amino acids increased, and the conversion efficiency of the precursor into HA was also significantly improved.

It can be seen from FIG. 1B that, in both the humification treatment group and the control group, the polyphenol content gradually decreased. Initially, the polyphenol content in the humification treatment group was 3.46 mg/g, and the polyphenol content in the control group was 1.54 mg/g. At a later stage of composting, the polyphenol content in the humification treatment group was 0.69 mg/g, and the polyphenol content in the control group was 0.6 mg/g. In the humification treatment group and the control group, conversion rates of polyphenols are 80.10% and 61.04%, respectively. These indicate that, after the directional humification treatment in the microfactory, the content of polyphenols increased, and the conversion efficiency of the precursor into HA was also significantly improved.

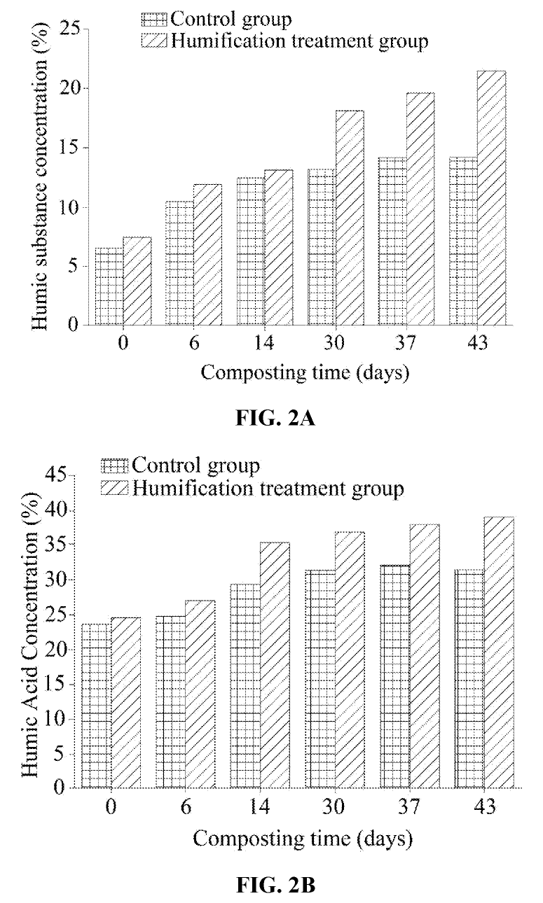

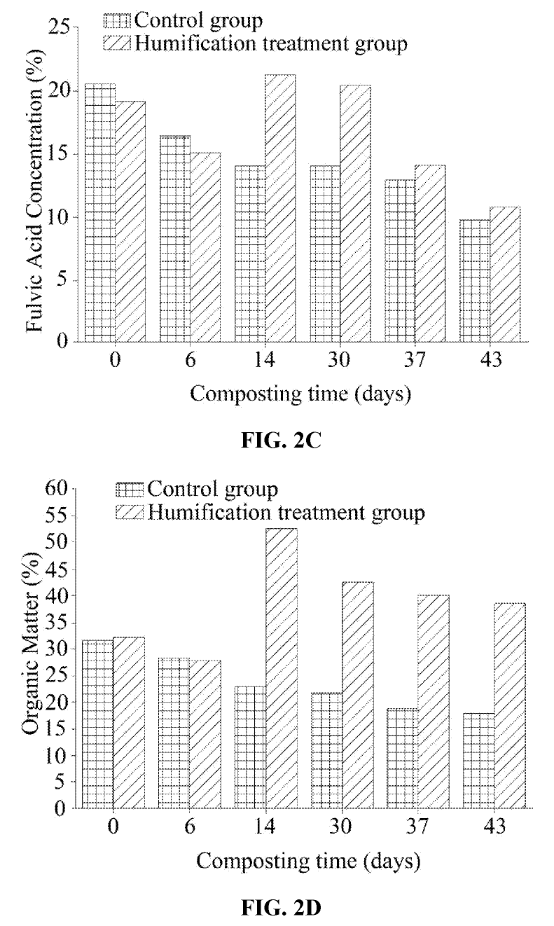

FIGS. 2A-2D show the dynamic changes in humic component contents during the aerobic fermentation process, including changes in the humic substance content, changes in the FA content, changes in the HA content, and changes in the organic matter content.

With the progress of composting, in the compost, both the humic substance content and the HA content gradually increased, the FA content decreased, and the organic matter content presented a trend of first decreasing, then increasing, and then decreasing. It can be seen that the compost underwent a vigorous humification process. In this example, the humic substance content in the humification treatment group is 20.73%, and the humic substance content in the control group is 13.24%, indicating an increase of 56.57% in the humification treatment group compared with the control group. It indicates that the humification treatment group adopting the directional humification microfactory could significantly increase the content of HA. Moreover, during the humification treatment, the content of organic matters significantly increased at a later high-temperature stage, and the maximum content of organic matters could reach 52.42%, which fully guarantees the lack of HA-limiting precursors and allows the efficient progress of humification. The content of organic matters in the control group was 22.98%, and the content of organic matters in the humification treatment group increased 1.2 times compared with the control group. Therefore, it can be concluded that there was a significant difference between the humification treatment group and the control group, and the humification treatment group enables a higher humic substance content, a more excellent and stable composting effect, and a better product quality than the control group.

### Example 2

A study on the immobilization and storage of HA produced after organic solid waste composting based on chitosan resulting from bioconversion of an aquatic waste was conducted.

### 1. Raw materials

An aquatic product processing factory near the Tianjin Port was selected as a demonstration project site for case implementation. The Tianjin Port is one of the important ports in the Northern China, and possesses rich marine resources. Therefore, the Tianjin Port is a region where there is a lack of lignocellulosic waste such as straws and there is an abundant amount of aquatic waste. In the raw material preparation unit for HA synthesis, a biological method was adopted, that is, an aromatic nucleus preparation process in which depolymerization of lignocellulose is enhanced with the crude enzyme broth from microbial inoculant fermentation was adopted. In the HA production unit, a process for directional humification based on protein waste composting combined with addition of HA-synthesizing aromatic nucleus precursor as a functional material was adopted. In the HA storage unit, a process for producing and immobilizing labile HA with shell-derived chitosan was adopted.

In this example, rice straws, chicken manure, and kitchen waste were used as the initial raw materials for composting. The raw materials were collected from a farm in Tianjin. In the experiment, a compounded lignocellulose-depolymerizing functional microbial agent was used to prepare fermented crude enzyme broth. Bacillus cereus was used as a bioconversion bacterial agent. Aromatic nucleus precursor functional materials used in the HA production unit were manganese sulfate and lignite. An aquatic waste including crab shell or clam shell was used as the humic substance-immobilizing agent. In this example, an aerobic composting method was modified according to local actual conditions. In this aerobic composting method, each component for composting was added at an amount according to the following standard: During an aerobic fermentation process for composting, the carbon-to-nitrogen ratio must be maintained at 25and the moisture content needed to be maintained at about 65%. An amount of the microbial agent-fermented crude enzyme broth inoculated was 1% of a dry weight of the composting raw material. The amount of the catalytic material of manganese sulfate added was 5‰ of a dry weight of the compost, the amount of the lignite added was 15% of the dry weight of the compost, and the amount of the aquatic waste added was 2.5% of the dry weight of the compost.

### 2. Aerobic fermentation

(1) In the raw material preparation unit for HA synthesis, the aromatic nucleus preparation process in which depolymerization of lignocellulose was enhanced with the crude enzyme broth from microbial inoculant fermentation was adopted.

Before aerobic fermentation was started, rice straws were crushed to a length of 2 cm to 3 cm, then the carbon-to-nitrogen ratio of the material was adjusted with urea to 25 to 30, and the moisture content of the material was adjusted with distilled water to about 65%. A compounded lignocellulose-depolymerizing functional microbial agent was selected for scale-up culture and inoculation to allow composting. For the activation culture, the ratio of the medium to the strain to be inoculated was 1,000:1. The activation culture was conducted at 45° C in a shake flask with a rotational speed of 130 rpm/min. When the concentration reached 1.0 × 10⁸ CFU/mL, a resulting activated microbial solution was inoculated into the available large fermentation tank in the plant for the scale-up culture. A microbial solution produced after the scale-up culture was inoculated into pre-treated straws at an amount 1% of a dry weight of the composting raw material.

(2) In the HA production unit, a process for directional humification based on protein waste composting combined with addition of HA-synthesizing aromatic nucleus precursor as a functional material was adopted.

About one week before the composting entered the high-temperature stage, lignite was added at an amount 15% of a dry weight of the composting raw material, manganese sulfate was added at an amount 5‰ of the dry weight of the composting raw material, so as to couple the precursor feeding with the catalytic materials to promote the directional humification of organic components. When the high temperature lasted for a long time, the above two catalytic materials were added once again during the high-temperature composting.

(3) In the HA storage unit, a process for producing and immobilizing labile HA with shell-derived chitosan was adopted.

Crab shells and clam shells as typical aquatic waste were used as raw materials for bioconversion. The amount of crab shell-derived chitosan added was 2.00% of a dry weight of the total materials, and the amount of clam shell-derived chitosan was 2.50% of the dry weight of the total materials. Bacillus cereus, a highly chitin-deacetylating functional strain, was inoculated into each shell waste at an amount 1% of a dry weight of the shell waste to allow large-scale fermentation of the above two shell wastes to produce chitosan as the crude product. The cycle of the large-scale fermentation was 5 d. According to the stoichiometric determination and calculation, the deacetylation degree of the crude chitosan converted from the crab shell was 46.60%, the deacetylation degree of the crude chitosan converted from the clam shell was 37.50%.

The above was a discription of directional humification microfactory. The material system treated by the three units was set as a humification treatment group, and the material system not treated by the three units was set as a control group. The two groups were simultaneously subjected to an aerobic fermentation experiment lasting for 43 d.

After the aerobic fermentation was completed, the compost was collected and analyzed for physical and chemical properties. The following conclusions were drawn:

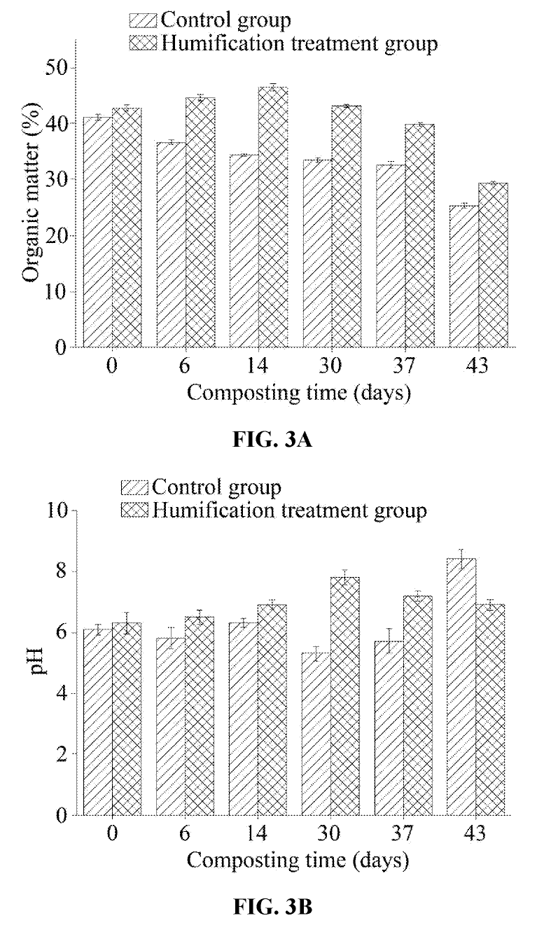

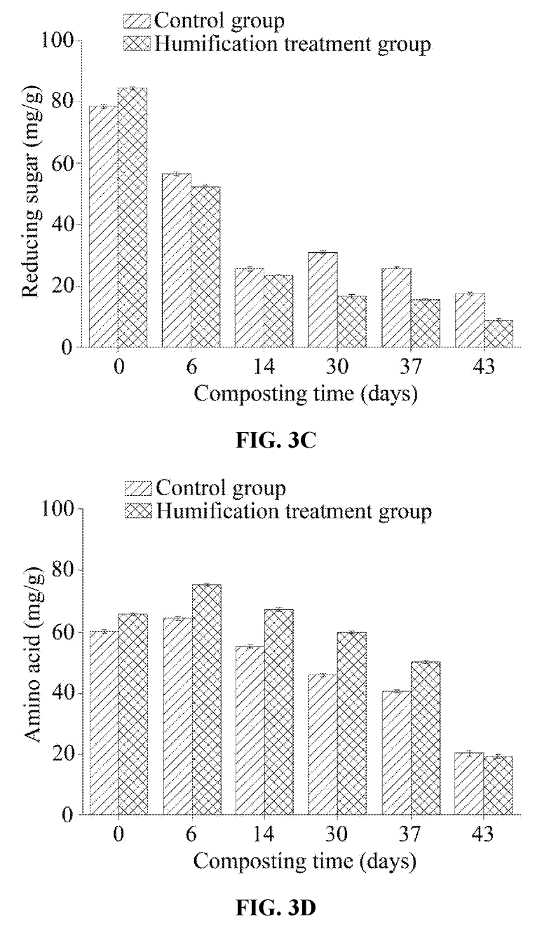

FIGS. 3A-3D show various physical and chemical indexes of the control group and the humification treatment group undergoing a three-unit treatment during the composting process, including dynamic changes in pH and organic matter, reducing sugar, and amino acid contents. According to the dynamic changes in the four physical and chemical indexes during composting, the following conclusions are drawn: In both the control group and the humification treatment group, the pH was stabilized at about 7. However, the humification treatment group was more inclined towards an alkaline environment. This is because alkaline matters are produced due to microbial metabolism during composting. Therefore, it can be inferred that the humification treatment group has a stronger microbial activity than the control group. Further, after the humification treatment, the content of organic matters in the compost significantly increased, which provides energy and a driving force for the progress of humification during composting. Moreover, the humification treatment group had a significantly-higher HA precursor content than the control group. The conversion efficiency of the precursor was significantly improved in the humification treatment group. It indicates that the humification treatment group underwent an intenser humification process than the control group. Therefore, it can be preliminarily determined that, after the humification treatment by the three units, the humification was intensified, and the degree of humification increased.

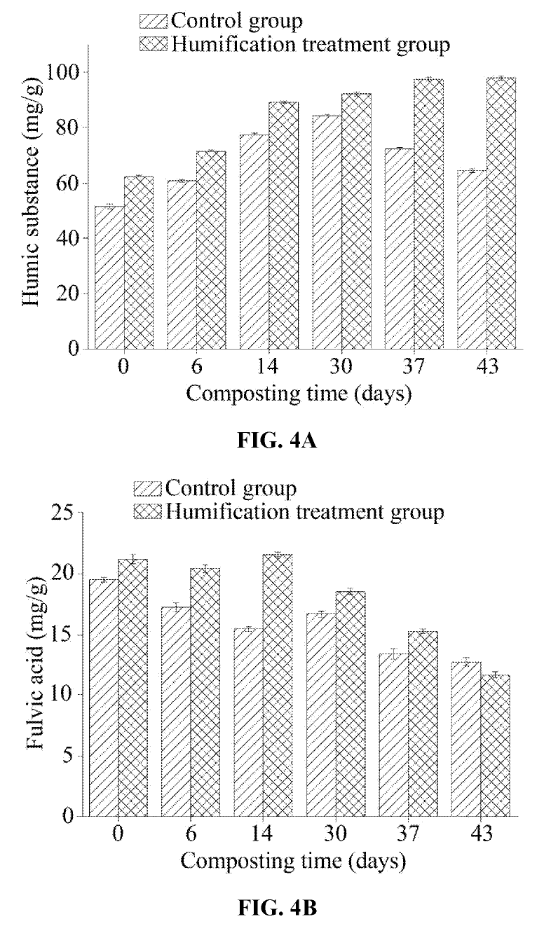

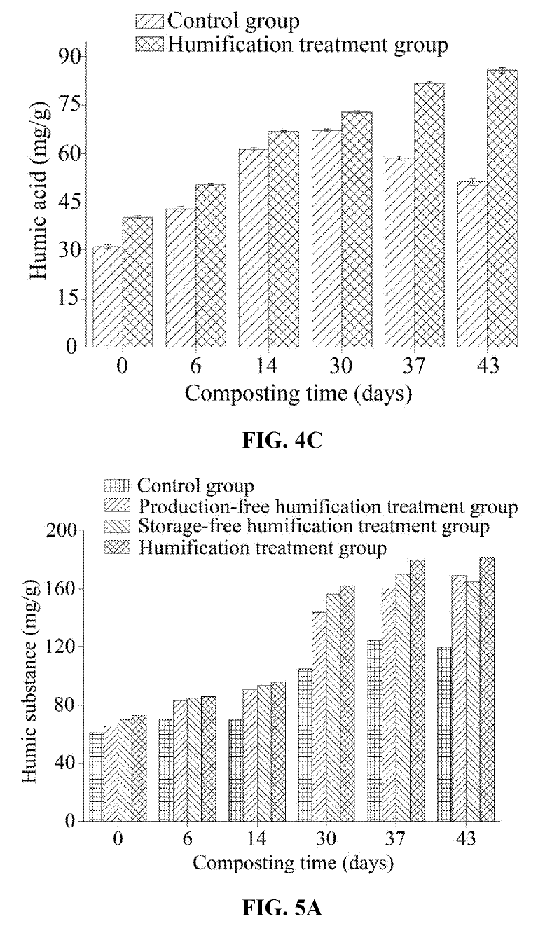

FIGS. 4A-4C show dynamic changes in the total content of humic substances and the content of each humic substance in the control group and the humification treatment group undergoing a three-unit treatment during composting. In the control group, the humic substance content increased from 51.4 mg/g to 64.5 mg/g, during which the humic substance content first increased and then decreased. This is because the instability in mineralization of HA leads to the loss of HA and the decrease in the humic substance content. In the humification treatment group, the humic substance content increased from 62.24 mg/g to 97.9 mg/g, during which the humic substance content continuously increased. The initial HA content in the humification treatment group was 21% higher than that in the control group, which is attributed to the following fact: In the humification treatment group, increased HA precursors are generated from the depolymerization in the raw material preparation unit for HA synthesis, and increased HA molecules are produced through the microbial metabolism and the synthesis and conversion of small and large molecules in the compost. At a later stage of composting, the HA content significantly increased in the humification treatment group. This is because the HA production and storage units greatly increase the content of HA and allows for the stable immobilization and storage of HA in the humification treatment group. Therefore, it can be concluded that the humification treatment group enables a higher HA content, more stable immobilization and storage of HA, a more excellent and stable composting effect, and a better product quality than the control group.

### Example 3

Response of HA to the staged feeding of a nitrogen-containing precursor was explored.

### 1. Raw materials

Northeast Agricultural University in Harbin was selected as a demonstration site for case implementation. Northeast Agricultural University is a major agricultural region, and thus is rich in lignocellulosic waste such as straws. Moreover, Northeast Agricultural University is located in a development zone with an abundant amount of waste loess from homesteads, and thus has abundant clay minerals. Therefore, in the raw material preparation unit for HA synthesis, a biological or non-biological coupling-enhanced depolymerization method was adopted, that is, a process for enhancing depolymerization of lignocellulose based on Fe(II)/functional microorganism-enhanced Fenton-like oxidation was adopted. In the HA production unit, a process for directional humification based on lignocellulosic waste composting and coupling of staged protein precursor feeding with functional material catalysis was adopted. In the HA storage unit, a process for passivating labile HA with clay minerals in aerobic fermentation was adopted.

Maize straws left after harvesting in the previous year were used as the humic substance-synthesizing raw material. Z1 strain (Aspergillus fumigatus) AF202956.1 (from the China General Microbiological Culture Collection Center (CGMCC)) was used as the lignin-depolymerizing strain. Ferrous sulfate was added for Fenton-like effect. The protein materials included kitchen waste, pig manure, and chicken manure, etc. Manganese sulfate was used as a catalyst for humification. Stratified clay minerals with strong adsorption capacity and waste loess from homesteads were used as the humic substance-immobilizing agent. In this example, the aerobic composting method was modified according to local actual conditions. In this aerobic composting method, each component for composting was preferably added at an amount according to the following standard: During the aerobic fermentation process for composting, the carbon-to-nitrogen ratio must be maintained at 28 and the moisture content needed to be maintained at about 65%. The amount of the microbial agent inoculated was 0.25% of a dry weight of the lignocellulosic material including straws. The amount of the protein material including chicken manure was 5% of a dry weight of the compost. The amount of the catalytic material manganese sulfate was 5‰ of the dry weight of the compost. The amount of the clay minerals added was 8% of the dry weight of the compost.

### 2. Aerobic fermentation

(1) In the raw material preparation unit for HA synthesis, a process for enhancing depolymerization of lignocellulose based on Fe(II)/functional microorganism-enhanced Fenton-like oxidation was adopted.

Before aerobic fermentation was started, rice straws were crushed to a length of 2 cm to 3 cm, then the carbon-to-nitrogen ratio of the material was adjusted with urea to 25 to 30, and the moisture content of the material was adjusted with distilled water to about 65%. Z1 strain was selected for scale-up culture and inoculation to allow composting. For the activation culture, the ratio of the medium to the strain to be inoculated was 1,000:1. The activation culture was conducted at 45° C in a shake flask with a rotational speed of 130 rpm/min. When the concentration reached 1.0 × 10⁸ CFU/mL, a resulting activated microbial solution was inoculated into the available large fermentation tank in the plant for scale-up culture. The microbial solution produced after the scale-up culture was inoculated into pre-treated straws at an amount 0.25% of a dry weight of the straws. The amount of the functional strain Z1 (Aspergillus fumigatus) added was 0.25% of the dry weight of the straws. Ferrous sulfate was added as Fe (II) at an amount 0.5% of the dry weight of the composting raw material. The weighed FeCl₂ was added to a specified amount of distilled water, and stirred with a glass rod. Because the specified amount of water was added during the process of dissolving FeCl₂, in order to maintain the moisture content at about 65% during the composting, the moisture content should be adjusted after the FeCl₂ solution was mixed with materials. In addition, Fe(II) did not need to be prepared in advance, and could be prepared just before use.

(2) In the HA production unit, a process for directional humification based on lignocellulosic waste composting and coupling of staged protein precursor feeding with functional material catalysis was adopted.

About one week before the composting entered the high-temperature stage, the protein precursors including chicken manure and kitchen waste were added at an amount 5% of a dry weight of the composting raw material, manganese sulfate was added at an amount 5‰ of the dry weight of the composting raw material, so as to achieve the coupling of precursor feeding with the catalytic material to promote the directional humification of organic components. When the high temperature lasted for a long time, the protein precursors were added once again during the high-temperature composting.

(3) In the HA storage unit, a process for passivating labile HA with clay minerals in aerobic fermentation was adopted.

For the selection of clay minerals, stratified clay minerals with a low cost, large specific surface area, and strong adsorption capacity, such as montmorillonite and zeolite, could be preferred, or loess with a lower cost than stratified clay minerals could be selected. Mountainous regions of Shanxi have abundant loess. Thus, waste loess from a homestead or a mountainous region were selected and added at an amount 8% of the dry weight of the composting raw material. Moreover, the particle size of loess should be reduced as much as possible, and clay minerals should be thoroughly mixed in the compost.

The above was a description of the directional humification microfactory. The material system treated by the three units was set as a humification treatment group, the material system not treated by the three units was set as a control group, the material system treated by the three units other than the HA production unit was set as a production-free humification treatment group, and the material system treated by the units other than the HA storage unit was set as the storage-free humification treatment group. The four groups were simultaneously subjected to an aerobic fermentation experiment lasting for 43 d.

After the aerobic fermentation was completed, the compost was collected and tested for dynamic changes in the humic substance content and the organic matter content. The following conclusions were drawn:

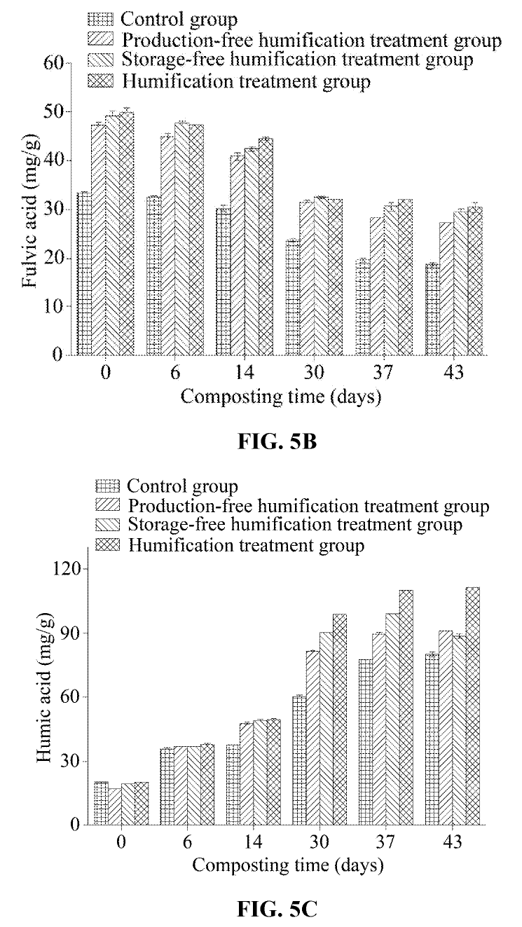

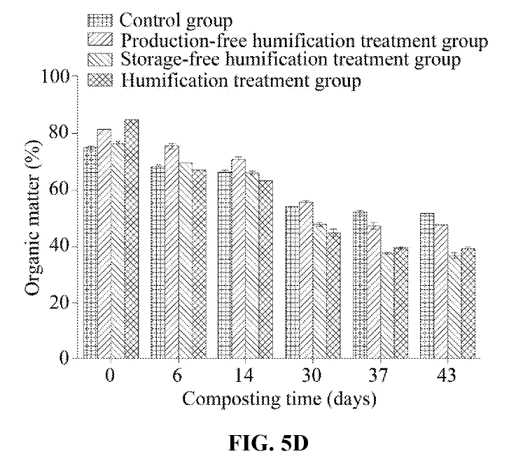

FIGS. 5A-5D show dynamic changes in the total content of humic substances, the content of each humic substance, and the content of organic matters in the control group, the production-free humification treatment group, the storage-free humification treatment group, and the humification treatment group during composting. According to the above indexes, the quality of the product and the degree of humification during composting were determined. As shown in FIGS. 5A-5D, humic substance contents and HA contents in the four groups each present a general upward trend. However, FA contents and organic matter contents each present a general downward trend, which is attributed to the consumption of organic matters and FA to synthesize HA during composting. Because HA is the basic humic substance, the humic substance and HA contents both were on the rise. According to the dynamic changes in humic substance contents, with the progress of composting, humic substance contents of the four groups were as follows: 120.01 mg/g < 168.42 mg/g < 164.23 mg/g < 180.86 mg/g. In the humification treatment group, the humic substance content was significantly improved, and HA could be stably stored at a later stage of composting to prevent the loss of HA caused by mineralization. In the storage-free humification treatment group, a high humic substance content was achieved at early to middle stages of composting, but there was a heavy loss of HA at the later stage, which makes the HA content reduced to be finally lower than that of the production-free humification treatment group. Therefore, the humification treatment group undergoing a three-unit treatment exhibited a significantly-better aerobic fermentation effect than the humification treatment groups undergoing a two-unit treatment. In addition, the immobilization of HA by clay minerals and the directional synthesis of HA based on the coupling of staged protein precursor feeding with functional material catalysis could increase the content of HA and ensure the stable humification of the compost.

The above are merely preferred embodiments of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A directional humification microfactory for agricultural waste composting, comprising the following treatment units arranged sequentially:
a raw material preparation unit for humic acid (HA) synthesis configured to allow enhanced depolymerization of lignocellulose to release an HA precursor;
an HA production unit configured to allow directional synthesis of an HA from the HA precursor ; and
an HA storage unit configured to immobilize and store the HA produced in composting.

2. The directional humification microfactory for the agricultural waste composting according to claim 1, wherein in the raw material preparation unit for the HA synthesis, a method for enhancing depolymerization of the lignocellulose is determined according to an abundance of a lignocellulosic waste in a composting raw material: when the lignocellulosic waste is deficient in the composting raw material, a biological enhanced depolymerization method is adopted; and
when the lignocellulosic waste is abundant in the composting raw material, a biological coupling-enhanced depolymerization method or a non-biological coupling-enhanced depolymerization method is adopted.

3. The directional humification microfactory for the agricultural waste composting according to claim 2, wherein the biological enhanced depolymerization method comprises a first aromatic nucleus preparation process, wherein in the first aromatic nucleus preparation process, the depolymerization of the lignocellulose is enhanced with a crude enzyme broth from microbial inoculant fermentation; and
the biological coupling-enhanced depolymerization method or the non-biological coupling-enhanced depolymerization method comprises at least one selected from the group consisting of the following: a process for enhancing the depolymerization of the lignocellulose based on Fe(II)/functional microorganism-enhanced Fenton-like oxidation, a process for enhancing the depolymerization of the lignocellulose based on KOH depolymerization-HNO=neutralization and microbial inoculation, and a second aromatic nucleus preparation process, wherein in the second aromatic nucleus preparation process, the depolymerization of the lignocellulose is enhanced based on coupling of Mn(II) with a functional microorganism.

4. The directional humification microfactory for the agricultural waste composting according to claim 1, wherein in the HA production unit, a method for the directional synthesis of the HA from the HA precursor is determined according to an abundance of a lignocellulosic waste in a composting raw material: when the lignocellulosic waste is deficient in the composting raw material, a process for directional humification based on protein waste composting combined with addition of an HA-synthesizing aromatic nucleus precursor as a functional material is adopted; and
when the lignocellulosic waste is abundant in the composting raw material, a process for directional humification based on lignocellulosic waste composting and coupling of staged protein precursor feeding with functional material catalysis is adopted.

5. The directional humification microfactory for the agricultural waste composting according to claim 1, wherein in the HA storage unit, a method for immobilizing and storing the HA is determined according to an abundance of minerals or chitosan in a composting region: when there is an abundant amount of clay minerals in the composting region, a process for passivating a labile HA with the clay minerals in aerobic fermentation is adopted;
when the composting region is a coastal region, a process for producing and immobilizing the labile HA with shell-derived chitosan is adopted, wherein in the coastal region, the shell-derived chitosan is abundant; and
in other composting regions, a microhabitat factor regulation process is adopted.

6. The directional humification microfactory for the agricultural waste composting according to claim 5, wherein a method for the aerobic fermentation is intermittent aeration.

7. The directional humification microfactory for the agricultural waste composting according to claim 6, wherein a process of the intermittent aeration is as follows: starting aeration at a beginning of the aerobic fermentation, making each aeration last for 2 h, and allowing the aeration once every 6 h,
wherein an aeration rate for each aeration is 0.25 L/min to 0.5 L/min.

8. A method of agricultural waste composting, comprising contacting a composting raw material with the directional humification microfactory for the agricultural waste composting according to claim 1.

9. The method according to claim 8, further comprising: adjusting a C/N ratio and a moisture content in the composting raw material before the enhanced depolymerization of the lignocellulose,
wherein a method for adjusting the C/N ratio in the composting raw material is as follows: adding urea to the composting raw material to adjust the C/N ratio to 25 to 30; and
the moisture content in the composting raw material is adjusted to 60 wt% to 70 wt%.

10. The method according to claim 8, wherein in the raw material preparation unit for the HA synthesis, a method for enhancing depolymerization of the lignocellulose is determined according to an abundance of a lignocellulosic waste in the composting raw material: when the lignocellulosic waste is deficient in the composting raw material, a biological enhanced depolymerization method is adopted; and
when the lignocellulosic waste is abundant in the composting raw material, a biological coupling-enhanced depolymerization method or a non-biological coupling-enhanced depolymerization method is adopted.

11. The method according to claim 10, wherein the biological enhanced depolymerization method comprises a first aromatic nucleus preparation process, wherein in the first aromatic nucleus preparation process, the depolymerization of the lignocellulose is enhanced with a crude enzyme broth from microbial inoculant fermentation; and
the biological coupling-enhanced depolymerization method or the non-biological coupling-enhanced depolymerization method comprises at least one selected from the group consisting of the following: a process for enhancing the depolymerization of the lignocellulose based on Fe(II)/functional microorganism-enhanced Fenton-like oxidation, a process for enhancing the depolymerization of the lignocellulose based on KOH depolymerization-HNO=neutralization and microbial inoculation, and a second aromatic nucleus preparation process, wherein in the second aromatic nucleus preparation process, the depolymerization of the lignocellulose is enhanced based on coupling of Mn(II) with a functional microorganism.

12. The method according to claim 8, wherein in the HA production unit, a method for the directional synthesis of the HA from the HA precursor is determined according to an abundance of a lignocellulosic waste in the composting raw material: when the lignocellulosic waste is deficient in the composting raw material, a process for directional humification based on protein waste composting combined with addition of an HA-synthesizing aromatic nucleus precursor as a functional material is adopted; and
when the lignocellulosic waste is abundant in the composting raw material, a process for directional humification based on lignocellulosic waste composting and coupling of staged protein precursor feeding with functional material catalysis is adopted.

13. The method according to claim 8, wherein in the HA storage unit, a method for immobilizing and storing the HA is determined according to an abundance of minerals or chitosan in a composting region: when there is an abundant amount of clay minerals in the composting region, a process for passivating a labile HA with the clay minerals in aerobic fermentation is adopted;
when the composting region is a coastal region, a process for producing and immobilizing the labile HA with shell-derived chitosan is adopted, wherein in the coastal region, the shell-derived chitosan is abundant; and
in other composting regions, a microhabitat factor regulation process is adopted.

14. The method according to claim 13, wherein a method for the aerobic fermentation is intermittent aeration.

15. The method according to claim 14, wherein a process of the intermittent aeration is as follows: starting aeration at a beginning of the aerobic fermentation, making each aeration last for 2 h, and allowing the aeration once every 6 h,
wherein an aeration rate for each aeration is 0.25 L/min to 0.5 L/min.
